(19) United States
(12) Patent Application Publication
(10) Pub. No.: US 2011/0161987 A1
(43) Pub. Date: Jun. 30, 2011

(54) SCALING NOTIFICATIONS OF EVENTS IN A SOCIAL NETWORKING SYSTEM

(76) Inventors: ANQI ANDREW HUANG, SAN FRANCISCO, CA (US); JONATHAN WARMAN, SAN FRANCISCO, CA (US); JOSH WISEMAN, SAN FRANCISCO, CA (US); EUGENE LETUCHY, SAN FRANCISCO, CA (US)

(21) Appl. No.: 12/649,705

(22) Filed: Dec. 30, 2009

(51) Int. Cl. G06F 9/46; G06F 15/16

(52) U.S. Cl. 719/318; 709/206; 709/204

(57) ABSTRACT

A social networking system notification system is scaled so a user is notified of an event when a unit or level of notification utility has been reached. For the average user, a single event may be noteworthy enough for which to receive a notification. However, when this user is especially important or highly connected (or received a large number of interactions), that user will have decreasing utility for each additional comment he has received. To manage these types of situations, and avoid inundating users with notifications that are of less utility to the user, the notifications are filtered/aggregated so that these users are notified less often. The notification scheme is optimized for each user, so the user is notified only when he has reached a level of notification utility.

### FIELD OF THE INVENTION

This invention pertains in general to social networking, and more specifically to managing notifications provided to a user of events occurring in a social networking system that relate to the user.

### BACKGROUND

A social networking system allows users to associate themselves with other users, thus creating a network of connections among the users of the social network and allowing the users to communicate information more efficiently. Individuals and other entities, such as businesses, can post content that they wish to enable and/or encourage other users to view, including text, status updates, location information, photos, videos, groups, events, and links to external websites as well as other pages in the social networking system, just to name a few. This content posted by a user of a social network is then delivered to the other users (“friends”) connected to the posting user via one or more of various communication channels in the social network, such as a newsfeed or stream. The other users can then review and comment on the posted content, and the posting user is typically notified of these comments or interactions by his connections.

Providing notifications to a user of a social networking system when another user has commented on or otherwise interacted with the user further encourages communication and interactions within a social network. Users commonly wish to be informed when one of their friends has attempted to interact by commenting on the user's photos or other of the user's information. In this manner, the user can keep up-to-date regarding the latest news or comments in his social network and quickly learn about new events relating directly to him.

In a very active social networking system or for a very active user with many friends, however, notifications can become quickly overwhelming. For the average user with a limited number of friends in a social network, a single comment from another user may be noteworthy enough for which to be sent a notification. However, when a user is a celebrity or is otherwise particularly important or highly connected, that user may receive thousands of comments from other users, and as such will have a decreasing utility for being notified about each additional comment he has received. Such users having a large number of friends (or “fans”) may not want to receive notifications about every action taken by all of those other users. Similarly, even a user with a limited number of connections can occasionally be inundated with interactions from other users on an intriguing new event or topic. While this user may wish to generally know when another user has commented on something he posted, he may not want to be flooded with notifications when a large number of other users suddenly comment at a single time on his posting. Social networks have not yet been able to manage their notification processes in a manner that avoids overwhelming their users in these types of situations.

### SUMMARY

A social networking system includes a notification system for generating and providing notifications to users regarding events that occur in association with those users. The social network notification system provides various scaling mechanisms that scale the rate or frequency with which notifications are sent to a given user, based on the utility to the user in receiving a further notification. More specifically, the notification system is configured so that a user is only notified of an event when a unit or level of utility has been reached for that particular user with respect to either the particular event itself, the type of event, the user or entity sending the event, or other criteria. In this manner, the notifications can be automatically optimized for different types of users.

Users with a large number of connections can receive notifications in a manner that allow those users to get the most value out of each notification. For example, the system can aggregate notifications by topic or by type. Users with a small number of connections in the social networking system can receive notifications of every or most events that occur involving that user or his friends, since each notification is more likely to be of interest to the user. Though, the notifications of these users with fewer connections can also be scaled to address situations where larger numbers of notifications are received at once, and each notification has less value to the user. The notification structure is varied to match each user, and can be varied across different events or event types for that user. Thus, the optimal notification scheme is applied for each user in each different situation.

One embodiment includes a computer-implemented method or a computer-readable storage medium for storing steps for providing a notification (or scaling notifications) to users for events associated with the users in a social networking system. The social networking system detects an event associated with a user (e.g., a comment or feedback by another user on that user's posted content) of a social networking system, where a number of other (e.g., prior) events have already occurred (e.g., other comments by other users on the posted content) in association with the user. The social networking system stores/references a notification scale having a number of levels of notification utility. Each of the levels can represent the value to the user in receiving an additional notification for an event that occurs in association with the user (e.g., the value to the user in receiving another notification of a comment on his posted content); this may be understood as the marginal utility of the event notification. Each level represents a specified number of events associated with a single user necessary to trigger a notification. The social networking system can maintain a count of each event occurring with respect to each user, such as the number of comments by others on a user's home page, the number of comments on a photograph uploaded by the user, and so forth. If the social networking system determines that the number of events (e.g., the current count including the new event) has reached the specified number of events (e.g., for a next level of notification utility) to trigger a notification, the social networking system provides a notification of the event to the user. If the current count has not yet reached the specified number, then the user is not notified of the event. In some embodiments, the affinity between users or other factors affect the rate or frequency with which notifications are sent.

Another embodiment includes a computer system for scaling notifications provided to users for new events associated with the users in a social networking system. An event detection module of the system detects an event associated with a user (e.g., a comment or feedback by another user on that user's posted content) of a social networking system, where a number of other (e.g., prior) events have already occurred in association with the user. A notification scale module stores/references a notification scale having a number of levels of notification utility. Each of the levels can represent the value to the user in receiving an additional notification for an event that occurs in association with the user (e.g., the value to the user in receiving another notification of a comment on his posted content); this may be understood as the marginal utility of the event notification. Each level represents a specified number of events associated with a single user necessary to trigger a notification. A notification module provides a notification of the event to the user if the social networking system determines that the number of events (e.g., the current count including the new event) has reached the specified number of events (e.g., for a next level of notification utility) to trigger a notification, the social networking system.

A further embodiment includes a computer-implemented method for providing/scaling notifications to users for new events based on user affinity represented in an affinity-based notification scale. The social networking system stores a first notification scale having a number of levels. Each level can represent the value to a first user in receiving additional notifications for events that occur in association with that user. Each level represents a first specified number of events. The social networking system further stores, for a second user (connected to the first user in the social networking system), a second notification scale (affinity-based). The second scale is customized to reflect a higher degree of interest of the first user in the second user than in other users connected to first user. Each level of the second notification scale is associated with a second specified number of events that is fewer than the first specified number of events. The social networking system detects an event (by the second user) associated with the first user. In response to determining that the current count of the number of events (including the new event) has reached the second specified number of events to trigger a notification, the social networking system provides a notification of the event to the first user.

An additional embodiment includes a computer-implemented method for scaling notifications provided to users for new events based on user affinity scores. The social networking system stores a notification scale having a number of levels of notification utility. Each level represents a value to a first user in receiving additional notifications for events that occur in association with the first user. Each level is associated with a specified number of events. The social networking system also stores, for the second user (connected to the first user in a social networking system), an affinity score indicating a higher degree of interest of the first user in the second user than in other users connected to the first user. The social networking system further detects, by a second user, a new event associated with the first user. The social networking system weights, based on the affinity score, the contribution of the new event by the second user to the current count of the number of events. In response to determining that the current count (including the new event) has reached the specified number of events for a next level of notification utility, the social networking system provides a notification of the new event to the first user.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram illustrating a system for scaling notifications provided to a user, in accordance with an embodiment of the invention.

FIG. 2 is a high-level block diagram illustrating a computer system for use with the invention.

FIG. 3 is a screen shot of a notification window on web page of a social networking system, in accordance with an embodiment of the invention.

FIG. 4 is a screen shot of a notification email on a web page of an email program, in accordance with an embodiment of the invention.

FIG. 5 is a flow chart of a process scaling notifications provided to a user, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. Introduction

A social networking system offers its users the ability to communicate and interact with other users (e.g., users). In some cases, users can connect via a social networking system. In use, users generally join the social networking system (become “members”) and then add connections to a number of other users to whom they desire to be connected. The terms “user” and “member” are both are intended to refer to any user of a social networking system. A user can be an individual person, a group (e.g., a band or club), a business enterprise, even a fictional character or entity. As used herein, the term “friend” refers to any other user to whom a user/user has formed a connection, association, or relationship via the social networking system. Connections may be added explicitly by a user, for example, the user selecting a particular other user to be a friend, or automatically created by the social networking system based on common characteristics of the users (e.g., users who are alumni of the same educational institution). Connections in social networking systems are usually in both directions, but need not be, so the terms “user” and “friend” depend on the frame of reference. For example, if Bob and Joe are both users and connected to each other in the social networking system, Bob and Joe, both users, are also each other's friends. The connection between users may be a direct connection; however, some embodiments of a social networking system allow the connection to be indirect via one or more levels of connections. Also, the term “friend” need not require that users actually be friends or even acquaintances in real life, (which would generally be the case when one of the users is a business or other entity); it simply implies a connection in the social networking system. Further, not all social networking systems require membership, so the term “user” can refer to any user interacting with or using a social networking system, with or without having a membership.

Though many of the embodiments/examples provided below are directed to a social networking system, the invention described herein is not limited to a social networking system, but can include other environments involving e-commerce systems, or other types of online systems and websites. For example, the social networking system could be implemented with an application that obtains information about a user's profile from the social networking system using, e.g., application programming interfaces (APIs).

### II. Overview of System Environment & Operation

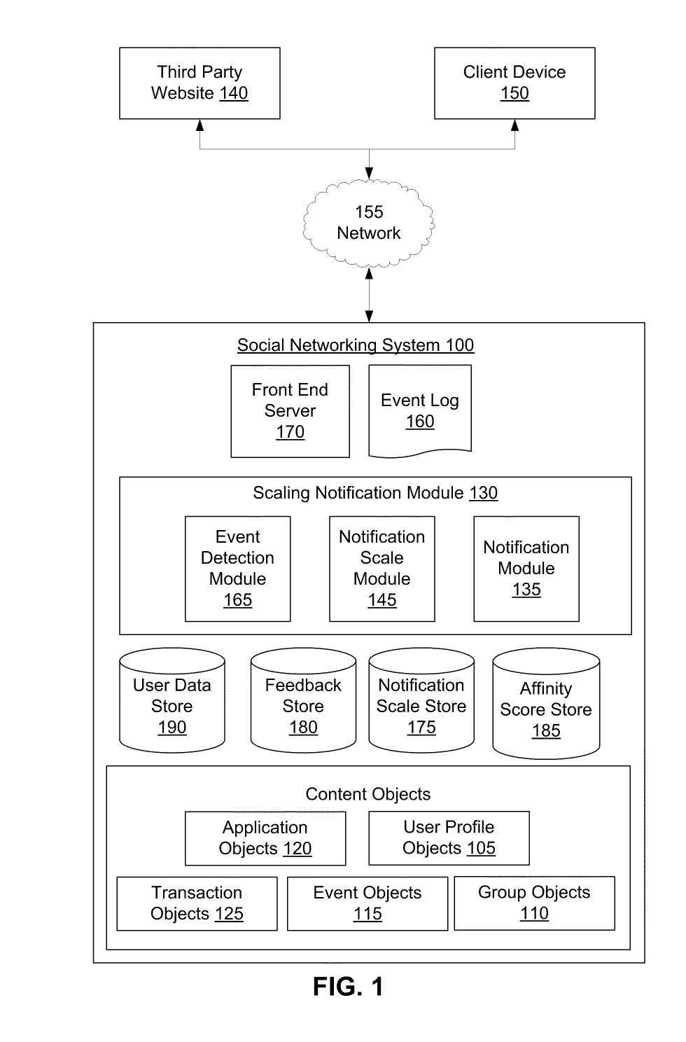

FIG. 1 illustrates an embodiment of the operational environment for a social networking system 100. The system environment comprises one or more client devices 150, one or more third-party websites 140, a social networking system 100, and a network 155. In alternative configurations, different and/or additional modules can be included in the system.

The client devices 150 comprise one or more computing devices that can receive user input and can transmit and receive data via the network 155. For example, the client devices 150 may be desktop computers, laptop computers, smart phones, personal digital assistants (PDAs), or any other device including computing functionality and data communication capabilities. The client devices 150 are configured to communicate via network 155, which may comprise any combination of local area and/or wide area networks, using both wired and wireless communication systems. As described above, the third party website 140 is coupled to the network 155 for communicating with the social networking system 100 about the users' actions off the system 100. While only a single client device 150 is shown, in practice the system 100 will be in communication with hundreds of thousands, even millions of client devices 150 at any time. Similarly, while only a single third party website 140 is shown, as is well known, there are millions of such sites that can communicate with the system 100.

The social networking system 100 comprises a computing system that allows users to communicate or otherwise interact with each other and access content as described herein. The social networking system 100 stores user profiles 105 that describe the users of a social networking system, including biographic, demographic, and other types of descriptive information, such as work experience, educational history, hobbies or preferences, location, and the like. The system 100 further stores data describing one or more relationships between different users. The relationship information may indicate users who have similar or common work experience, group memberships, hobbies, or educational history. Additionally, the social networking system 100 includes user-defined relationships between different users, allowing users to specify their relationships with other users. For example, these user-defined relationships allows users to generate relationships with other users that parallel the users' real-life relationships, such as friends, co-workers, partners, and so forth. Users may select from predefined types of relationships, or define their own relationship types as needed.

The social networking system 100 further includes a front end server 170, an event log 160, and a scaling notification module 130, which includes an event detection module 165, a notification scale module 145, and a notification module 135. The social networking system 100 also includes a user data store 190, a feedback store 180, a notification scale store 175, and an affinity score store 185. In other embodiments, the social networking system 100 may include additional, fewer, or different modules/stores for various applications. Likewise, the functionalities can be distributed among the modules in a manner different than described here. The operations of the various modules will be further described below.

As illustrated, the social networking system 100 maintains a number of objects for the different types of content objects with which a user may interact on the system 100. In one example embodiment, these objects include user profiles 105, group objects 110, event objects 115, application objects 120, and transaction objects 125 (respectively, hereinafter, groups 110, events 115, applications 120, and transactions 125). In one embodiment, an object is stored by the system 100 for each instance of its associated item. For example, a user profile 105 is stored for each user who joins the system 100, a group 110 is stored for each group defined in the system 100, and so on.

The user of the system 100 may take specific actions on the system 100, where each action is associated with one or more objects. The type of actions that a user may perform in connection with an object is defined for each object and largely depends on the type of item represented by the object. A particular action may be associated with multiple objects. Described below are a number of examples of particular types of objects that may be defined for the social networking system 100, as well as a number of actions that can be taken for each object. These objects and the actions discussed herein are provided for illustration purposes only, and it can be appreciated that an unlimited number of variations and features can be provided on a social networking system 100.

The social networking system 100 maintains a user profile 105 for each user of the system 100. Any action that a particular user takes is associated with the user's profile 105. For example, the user can provide content to the system 100 (e.g., photos, photo albums, videos, personal information, and other content), provide updates of the user's status or comments (e.g., included as a news story or news feed/live stream on a user's homepage or the user's “wall”), and so forth. The users can also take actions with respect to other users, which are associated with each user's profile 105. Such actions may include, for example, adding a connection to the other user, sending a message to the other user, reading a message from the other user, viewing content associated with the other user, attending an event posted by another user, tagging another user in a photo, commenting on content or comments/updates posted by other users, indicating likes/dislikes regarding content/comments/updates, requesting or accepting connections with other users, becoming a fan of a user or entity, among others. As noted above, the user can also have a homepage or wall associated with his profile on which he can post comments/status updates, and on which he receives a newsfeed or live stream providing news stories (e.g., one or a few lines of status information or comments from friends) that are relevant to the particular user.

A group 110 may be defined for a group or network of users. For example, a user may define a group to be a fan club for a particular band. The system 100 would maintain a group 110 for that fan club, which might include information about the band, media content (e.g., songs or music videos) by the band, and discussion boards on which users of the group can comment about the band. Accordingly, user actions that are possible with respect to a group 110 might include joining the group, viewing the content, listening to songs, watching videos, and posting a message on the discussion board.

Another type of object is an event object 115 that may be defined for a particular event, such as a birthday party. A user may create the event object 115 by defining information about the event such as the time and place and a list of invitees. Other users may accept the invitation, comment about the event, post their own content (e.g., pictures from the event), and perform any other actions enabled by the system 100 for the event object 115. Accordingly, the creator of the event object 115 as well as the invitees for the event may perform various actions that are associated with that event object 115.

The social networking system 100 may also enable users to add applications to their profiles. These applications provide enhanced content and interactivity within the social networking system 100, which maintains an application object 120 for each application hosted in the system. The applications may be provided by the website operator and/or by third party developers. An example application is an enhanced messaging service, in which users can send virtual objects (such as a “gift” or “flowers”) and an optional message to another user. The use of any functionality offered by the application may thus constitute an action by the user in connection with the application 120. In addition, continuing the example from above, the receipt of the virtual gift or message may also be considered an action in connection with the application 120. It can therefore be appreciated that actions may be passive and need not require active participation by a user.

Another type of object shown in the example of FIG. 1 is a transaction 125. A transaction object enables users to make transactions, such as buying, selling, renting, trading, or exchanging with other users. For example, a user may post a classified ad on the social networking system 100 to sell a car. The user would thus define a new transaction 125, which may include a description of the car, a picture, and an asking price. Other users can then view this information and possibly interact further with the transaction 125 by posting questions about the car and accepting the offer or making a counteroffer. Each of these interactions—view, question posting, offer, and counteroffer—are actions that are associated with the particular transaction 125. There are many other objects with which the user can interact, and FIG. 1 illustrates just a few of those objects.

Users can interact with the social networking system 100 in various manners. In one embodiment, a user interacts with the system 100 by posting a photo, joining a group, commenting on something, providing a status update, etc. Other users (e.g., friends of the user) can respond or otherwise interact with the user by commenting on the photo or group, responding to the user's comments or status update, adding a connection to the user, sending a message to or reading a message from the user, viewing content associated with the user, attending an event posted by the user, tagging the user in a photo, commenting on content/comments/updates posted by the user, indicating likes/dislikes regarding content/comments/updates, requesting or accepting connections with the user, becoming a fan of a user or entity, interacting with the user via an application, inviting the user to join or connect to another user, providing a friend/connection suggestion, providing various other requests/invitations/suggestions, among others. This response is a new event associated with a user about which the user could receive a notification. As used herein, the phrase “a new event associated with a user” includes any type of action that can occur with regard to a user about which the user can receive a notification. Thus, an “event” or a “new event” includes interactions of other users (e.g., friends of the user) with the user himself or with content posted by the user. A new event associated with a user A can include a response/comment or interaction (including indications of likes/dislikes) by a user B on any of the following: photos, videos, or other content posted by the user A, status updates for the user A, the user A's wall, homepage, or profile, or any other interaction with content provided by the first user. A new event can further include comments by additional users (e.g., friends of a first user) following a user A's comment on some content. A new event can also include an interaction with the user A himself by user B, including a connection request by user B for user A, a wall post by a user B on the user A's wall, and so forth.

When any user takes an action or creates an event on the social networking system 100, the action/event is recorded in a log, such as event log 160. The user can post content on or otherwise take an action associated with the system 100, and a number of events can occur regarding that content/action (e.g., friends can interact with or comment on that content). The events generated can be recorded in the event log 160. In one embodiment, the system 100 maintains the event log 160 as a database of entries. When an event occurs on the system 100, the system 100 adds an entry for that event to the log 160. The social networking system 100 also logs events that occur on a third party website 140 or actions taken by its users in the real world on an client device 150 (e.g., credit card transactions, tracking of a user's location, program material accessed by a user on a television system, etc.). The social networking system 100 can learn of these types of actions via a message from the third party website or via recording of the action by the client device 150. The actions can generate events that can be stored in the event log 160. Events of various types of are detected by the event detection module 320, as described in more detail below.

To determine whether or not to send a notification to the user regarding a new event detected, the system 100 uses the scaling notification module 130. This module 130 references/retrieves notification scale data for the user stored in a notification scale store 175. The notification scale includes a number of notification utility levels, where each level represents the utility value to the user in receiving additional notifications for events that occur in association with the user. In one embodiment, the utility value is a function of the event and/or the affinity for the user to another user interacting with the event. Throughout the description, the terms “value” and “utility,” or “utility value” are used interchangeably. The notification scale is specific to the user, and can be further specific to each type of event and each instance of a content object which the user contributes to the system 100.

The scaling notification module 130 determines a current count of the number of events associated with the user that have occurred including the new event, and determines whether the next level of notification utility has been reached with the new event. If so, the scaling notification module 130 causes a notification to be provided or made available to the user, otherwise the user is not notified of the new event. For example, if the user has already received many notifications about comments of his friends on his status update, it may be of less value to him to receive yet another notification of a new comment by a friend. To manage this, a notification scale is used to automatically track levels of utility to the user in receiving more notifications about comments. The notification scaling is described in more detail below.

### III. Client Device Architecture

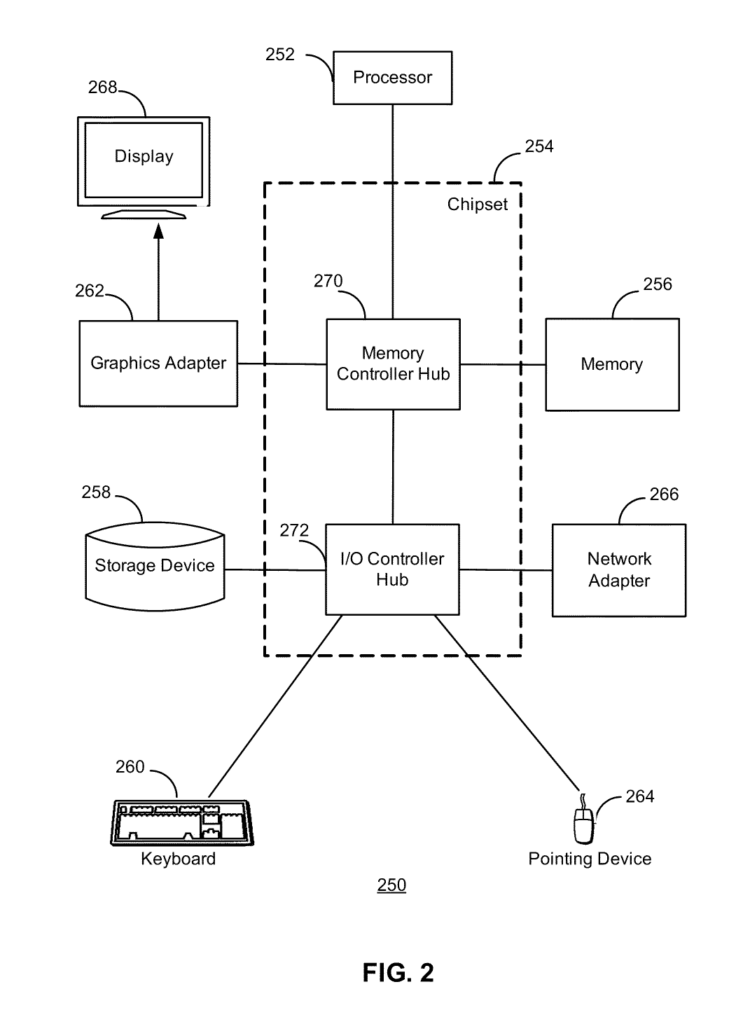

FIG. 2 is a high-level block diagram illustrating an example of a client device 150. Illustrated are at least one processor 252 coupled to a chipset 254. The chipset 254 includes a memory controller hub 270 and an input/output (I/O) controller hub 272. A memory 256 and a graphics adapter 262 are coupled to the memory controller hub 270, and a display device 268 is coupled to the graphics adapter 262. A storage device 258, keyboard 260, pointing device 264, and network adapter 266 are coupled to the I/O controller hub 272. Other embodiments of the computer 250 have different architectures. For example, the memory 256 is directly coupled to the processor 252 in some embodiments.

The storage device 258 is a computer-readable storage medium, such as a hard drive, compact disk read-only memory (CD-ROM), DVD, or a solid-state memory device. The memory 256 holds instructions and data used by the processor 252. The pointing device 264 is a mouse, track ball, or other type of pointing device, and is used in combination with the keyboard 260 to input data into the computer system 250. The graphics adapter 262 displays images and other information on the display device 268. The network adapter 266 couples the computer system 250 to the network 155. Some embodiments of the computer 250 have different and/or other components than those shown in FIG. 2. The computer 250 is adapted to execute computer program modules or computer program instructions and other logic used to provide a specified functionality. The executable computer program instructions can be stored on the storage device 258, loaded into the memory 256, and executed by the processor 252.

### IV. System Architecture for the Social Networking System

Referring again to FIG. 1, the particular modules of the social networking system are now described. The front end server 170 links the social networking system 100 via the network 155 to one or more client devices 150, as well as to one or more third party websites 140. The front end server 170 may include a mail server or other messaging functionality for receiving and routing messages between the social networking system 100 and the client devices 150 or third party websites 140. The messages can be instant messages, queued messages (e.g., email), text and SMS messages, or any other suitable messaging technique. The front end server 170 maintains the web pages and profiles associated with the social networking system for a number of users.

The event detection module 165 detects a new event associated with a user of the social networking system 100 by analysis of the event log 160 or querying of the event log 160 or an event log reporting service. Similarly, new events or notifications of new events can be received by the event detection module 165 from the event log 160/event log reporting service (e.g., by subscribing to the event log reporting service).

As explained above, the new event is something that occurs in association with a user or content associated with the user. In one embodiment, the user initiates the process by taking some action or interacting with another user (e.g., a friend) or content associated with such other user. The other user/friend then responds or interacts back with the user, which interaction can be the basis for a notification to be sent to the user. For example, User A might provide a status update (i.e., the initiating action) for himself that is then sent to his friends. One of his friends, User B, comments on User A's status update, thereby creating a new event associated with User A. A notification for this event can be created and provided to User A (e.g., “User B commented on your status update”). The module 165 detects the new event by User B, but in some embodiments can also detect the initiating action by User A.

Additionally, the new event need not be initiated by the user who will receive the notification, but instead can be initiated by the other user/friend. For example, User B could post something on User A's wall, thereby generating a new event about which User A can receive a notification (e.g., “User B wrote on your wall”). Further, as illustrated above, some new events are interactions with content posted by a user (e.g., a comment on the user's photo album), while other new events are interactions with the user himself (e.g., a connection request sent to the user).

As new events occur, these can be logged in the event log 160. There can be one log 160 storing all events for a user, or there can be multiple logs that can be divided, for example, by a particular interaction or content item (e.g., a log for all events associated with a particular photo) or by an event type (e.g., a log for all events associated with photos, in general). In some embodiments, a new log is further created for every new event or interaction with a user. In other embodiments, an event log 160 is created for an event (if a log does not already exist) and then the existing log 160 is updated as new events occur (i.e., a user's event log regarding comments on his posted video can be updated as new comments occur). After an amount of time, the event log 160 will become populated with a number of entries that describe events created on the social networking system 100. The event log 160 thus contains a very rich set of data about the actions or events of the users, and can be analyzed and filtered to identify trends and relationships in the actions of the users, as well as affinities between the users and various objects or other users.

The event log 160 can include various different types of information regarding events. In one embodiment, the event log 160 records the following: (1) the parties involved an interaction (including interactions from user A to user B, and interactions from user B to user A), (2) the object/context, or an identifier for the object, with which the interaction is occurring (e.g., a particular photo ID), (3) the event type or interaction type (e.g., comments, photos, wall posts, etc.), and (4) a time stamp for the event (e.g., the time the log entry was created, the time the log was updated, etc.).

In one embodiment, the time stamp further includes an unread count, or a count of how many notifications have been provided to a user that still have not been read by the user. This can be tracked, for example, by detecting when a user clicks on a link in the notification. In some embodiments, the event log 160 further records the current event count. This record of event count can include a count of all events for a user (e.g., everything that happens to the user in the social networking system) and/or all events of a particular type for a user (e.g., everything that happens to the user regarding all his photos) and/or all events associated with a particular content item or interaction (e.g., everything that happens to the user regarding a particular photo). Thus, in some embodiments, a record is kept per item of content per user. In addition, the records can be kept per time window. After a certain amount of time has passed (e.g., a day, a week, a month, etc.) or after a thread of events appears to have ended or has had a time break, the record can be ended/erased. If the events start up again, a new record can be generated for this new thread.

The user data store 190 stores information about each user of a social networking system. It can include information about each user's connections, user profile data, and other user-specific information. This information in the user data store 190 can be accessed by various modules of the system 100 where data is needed about a particular user. For example, when creating or updating an event log 160 that includes entries about interactions between two users, the user data store 190 can be accessed to retrieve relevant user-specific data or user IDs.

The notification scale module 145 creates and stores notification scales for users in the notification scale store 175, and references/accesses these scales for providing notifications to users. The module 145 can access the event log 106 for information regarding different events to use in creating/storing a notification scale. A user is sent notifications of new events according to the notification scale, and is only provided with a notification when a level of notification utility has been reached.

A notification scale has a plurality of levels. Each level is associated with a specified number of events, and the number of events required to reach a next level of the scale increases as a total number of events detected for the user increases. Levels can be defined in terms of total number of events since the first event, or a rate of events over time (e.g., number of events in the last week, day, hour, minute, etc.). In some embodiments, for each level, there is a rate at which notifications of events are to be sent to the user. Thus, while the total number of events is above the number specified for an i^{th} level, and below the number specified for the i+1^{th} level (or equivalent, within the range set for the i^{th} level), the event notifications are sent at the rate set for the i^{th} level.

Generally, for each user, the current count of all events that occur for the user is maintained; additionally individual counts may be maintained for the user per event type (comments, posts, etc.) or per individual item of content (e.g., per photo, per message, etc.). As new events occur, the total count (and any type or item counts) is incremented. When the number of events occurring for a user has reached a notification utility level in a corresponding notification scale, a notification of the event is sent to the user.

The notification scale module 145 stores one or more notifications scales for each user, and the scales for a user are specific to that user. Each of the levels of the notification scale represents the utility value to the user in receiving additional notifications for events that occur in association with the user, thus providing a measure of marginal utility to the user for the additional notification. For example, a user with a large number of connections (e.g., a celebrity) may not wish to be notified of every comment or interaction he receives in the social networking system 100, since he may receive hundreds or thousands a day. For such a user, there is presumably very little utility value in receiving a notification of the 357^{th} comment on a particular photograph provided by the user; instead, it may be more valuable to such a user to be notified of the first 100 comments, and then only the 200^{th}, 500^{th}, and every 1000^{th} comment thereafter. However, a user with only a few friends may wish to receive notifications of every interaction associated with him. The notification scale module 145 is adapted to manage both of these situations since each user can have one or more notification scales specific to him. A user's own notification scales are designed to ensure that the notifications provided to a particular user are of significant utility, so he receives notifications in accordance with his information needs. To better understand the notification scales, a few examples are provided below.

The notification scale can be implemented in a number of ways. In some embodiments, the notification scale is stored as a table or list of individual levels. In a simplified form provided for example only, a notification scale for a typical user may represent the following values:

| Level | Event Count |
|---|---|
| 1 | 1 |
| 2 | 2 |
| 3 | 3 |
| 4 | 4 |
| 5 | 5 |
| 6 | 25 |
| 7 | 50 |
| 8 | 100 |
| 9 | 200 |
| 10 | 500 |
| . . . | . . . |

Here, the user receives a notification of each of the first five events, and then only notifications of the 25^{th}, 50^{th}, 100^{th}, 200^{th}, 500^{th} events, and so on. Note, the representation of the level value is shown here only for purposes of explanation. In practice, the level number need not be explicitly stored in the notification table, as further examples below will illustrate.

In other embodiments, the notification scale can be implemented as a formula, function, or set of rules defining the levels can be used/stored. For example:

| | | Notification |
|---|---|---|
| Level | Event Count | Function |
| 1 | 0-100 | 1:1 |
| 2 | 101-500 | 1:10 |
| 3 | 500-1000 | 1:50 |
| 4 | >1000 | 1:100 |

Here, the function indicates the rate of notification per events. Thus, in level 1, while the count of events is between 0 and 100, notifications are sent at a rate of one notification per one event. When the event count reaches 101 and is less than 500, the notifications are sent at a rate of one notification for every 10 events, and so on. Further examples of the notification scales and the content of specific notifications are given below.

In one embodiment, exponential decay is applied after the first N events for providing a notification for every X events, where X is a specified number of events. For example, after the first C events, a notification is sent out for every K, K², K³, K⁴ . . . K^{x} (e.g., C=10 for the first 10 events, which each receive their own notification, and K=2, K²=4, K³=8, K⁴=16, K^{x}=2^{x}. Other scales can also be used, such as logarithmic, polynomial, Fibonacci, etc., in order to obtain levels that give a desired rate of notification. For the purposes of illustration, the examples below focus on tables to demonstrate the notification scales.

The notification scales can be arranged in a number of manners. In one embodiment, the notification scale module 145 stores a different notification scale for each of a number of specific content items (e.g., a specific photo or video). In other words, a user will have a plurality of notification scales specific to him, and within this group, there will be a separate notification scale for each set of events associated with a particular content item or interaction associated with the user. For example, a user can have multiple notification scales, including one scale for a collection of new events associated with a photo he posted, a second scale for events relating to his posted status update, and a third scale for a post on his wall. If a friend comments on the post on the user's wall, this new event is associated with the third notification scale. If this new comment moves the count of events on the third scale to a notification utility level, then the user can receive a notification.

With this type of notification scale arrangement, a user can receive a number of comments on a particular content item that are all associated with one scale. The number of events required to reach a new level of notification utility for the user increases as a total number of events detected for that content increases. Consider the example below.

Bob Posts a Particular Photo A

$$( 1 ) Karen comments on the photo \text{:} “ Wow , that is a great photo ! ”$$

$$( 2 ) Jim comments on the photo \text{:} “ Great shot ! ”$$

$$( 3 ) Eric comments on the photo \text{:} “ Where did you take that shot ? ”$$

$$( 4 ) Tina comments on the photo \text{:} “ Lovely ! ”$$

$$( 5 ) James comments on the photo \text{:} “ Good one ! ”$$

$$⋮ \\ ( 10 ) Jan comments on the photo \text{:} “ Beautiful ! ”$$

Further assume the notification scale for Bob is as follows:

| Level | Event Count |
|---|---|
| 1 | 1 |
| 2 | 2 |
| 3 | 3 |
| 4 | 4 |
| 5 | 5 |
| 6 | 10 |
| 7 | 50 |
| 8 | 100 |
| . . . | . . . |

For the first five comments, Bob receives a notification of each new event (e.g., “Karen commented on your photo,” “Jim commented on your photo,” . . . etc.). In this case, a notification utility level is reached with each new event (i.e., only one event is required to reach each new level up to five events). However, after five events, it takes more events to reach the next level. In this example it takes five more events (10 total) to reach the next level at which Bob gets a notification; thus on the tenth event from Jan, level 6 is reached. Instead of notifying Bob for each of events six through ten, Bob gets a single summary notification when Jan comments on the photo (e.g., “Five more people have commented on your photo”). The notification scale in this example is arranged so that from this point forward, Bob only gets notifications per increment on the scale. He may next get a notification that “Forty more people have commented on your photo,” and then “Congratulations! One hundred people have commented on your photo!” As shown in the table, Bob's notification utility levels for this photo are at each of events 1-5, at event 10, at event 50, at event 100, and so forth. This is illustrated in the example below.

### Bob Posts a Particular Photo A

$$( 1 ) Karen comments on the photo \to Bob ’ s notification \text{:} “ Karen commented on your photo . ” \\ ( 2 ) Jim comments on the photo \to Bob ’ s notification \text{:} “ Jim commented on your photo . ” \\ ( 3 ) Eric comments on the photo \to Bob ’ s notification \text{:} “ Eric commented on your photo . ” \\ ( 4 ) Tina comments on the photo \to Bob ’ s notification \text{:} “ Tina commented on your photo . ” \\ ( 5 ) Jam es comments on the photo \to Bob ’ s notification \text{:} “ James commented on your photo . ” \\ ⋮ \to No notification for comments 6 \text{-} 9 \\ ( 10 ) Jan comments on the photo \to Bob ’ s notification \text{:} “ 5 more people commented on your photo . ” \\ ⋮ \to No notification for comments 11 \text{-} 49 \\ ( 50 ) Fred comments on the photo \to Bob ’ s notification \text{:} “ Forty more people commented on your photo . ” \\ ⋮ \to No notification for comments 31 \text{-} 79 \\ ( 100 ) Fred comments on the photo \to Bob ’ s notification \text{:} “ Congratulations ! 100 people have commented on your photo ! ”$$

The above examples showed the basic aspects of a user specific notification scale. As noted, for a given user, there can be multiple different notification scales, with a particular scale associated with each individual item of content provided by (or associated with) a specific user. The following table shows an example of this approach.

| Total | | | | | | | |
|---|---|---|---|---|---|---|---|
| Event | Photo | Photo | Wall | | | | |
| Count | A | B | Post A | Update A | Update B | Video A | . . . |
| 1 | x | x | x | x | x | x | |
| 2 | x | x | x | | | x | |
| 3 | x | x | | | | x | |
| 4 | x | x | | | | x | |
| 5 | x | | x | x | x | x | |
| . | . | . | . | . | . | . | |
| . | . | . | . | . | . | . | |
| . | . | . | . | . | . | . | |
| 10 | x | | | x | x | x | |
| . | . | . | . | . | . | . | |
| . | . | . | . | . | . | . | |
| . | . | . | . | . | . | . | |
| 50 | x | x | x | | | | |
| . | . | . | . | . | . | . | |
| . | . | . | . | . | . | . | |
| . | . | . | . | . | . | . | |
| 100 | x | x | x | x | x | x | |
| 200 | x | | x | x | x | | |
| . | . | . | . | . | . | . | |
| . | . | . | . | . | . | . | |
| . | . | . | . | . | . | . | |
| 500 | x | | x | | x | | |
| . | . | . | . | . | . | . | |
| . | . | . | . | . | . | . | |
| . | . | . | . | . | . | . | |
| 1000 | x | x | x | x | x | x | |
| . | . | . | . | . | . | . | |
| . | . | . | . | . | . | . | |
| . | . | . | . | . | . | . | |

This table shows the use of multiple notification scales for a user. There is a different scale for each photo, each wall post, each status update, each video, and for each other content item or interaction with the user that can occur, which are shown in the top row. The first column shows a count of events that can occur (e.g., each comment on photo A), and the “x” in the column under an item indicates that a notification is sent out at that count value, thus establishing a level of notification utility. At each level where there is an “x” in the column for an item, a notification is sent to the user. As the table illustrates, the notification utility levels can be the same for different event types (e.g., levels are the same for different photos), though they can also differ (e.g., more notifications received for photo A than for B). However, the current event count on the notification scale may be different for photo A versus photo B (e.g., only 2 comments have been received for photo A, but 50 on photo B). Further, different event types can have different patterns. For example, where comments are received on a status update, the notifications of these are received less often than where comments are received on a photo.

Moreover, the use of multiple notification scales is not limited to particular types of content, but can apply to postings or comments by specific users of interest. For example, if a user is particularly interested in the postings of another user, (e.g., User A is particularly interested in being notified of a particular friend's postings about his photos, or postings by any of his children), a separate notification scale can be used to provide notifications of postings from that other user. The user's particular friend can have a different notification scale than is applied for other friends/connections. In this case, the table above that shows multiple notification scales for a user could include more “x's” in the boxes for the particular friend, or more event count levels that result in a notification being sent. Instead of being notified for the first 5 photo events, then for photo event 10, photo event 50, photo event 100, etc., the user might be notified about the first 10 photo events by the particular friend, and then at every 10 photo events thereafter. The notification scale for the particular friend (or for a user-specified group of particularly important friends) can be defined by the user, can be automatically set by the system (e.g., a system-defined important friends scale), can be defined based on affinity scores or ratings by the user (e.g., all users rated “1” as the highest importance/affinity level have one system-defined scale, all users rated “10 as the lowest importance/affinity level have another scale, etc.), and so forth. In some embodiments, the user can also adjust settings in his profile to indicate his preferences (e.g., send me more or all photo events for important friends, send me fewer wall post events for all friends, etc.). In another embodiment, a first user having a high affinity or importance to a second user can be an exception in the event counting system in which a notification is always sent to the second user for a first user's event (or is always sent for the first user's events of a particular type) regardless of the event count.

The notification scale module 145 can be configured to so that the patterns or levels of notification can differ across users in various ways. In one embodiment, the same notification scale is applied by the notification scale module 145 to a particular event type for all users. In another embodiment, the same notification scale is applied across users with similar characteristics. For example, for all users with a small number of friends (e.g., 100 or less), the notification scales for all their photos are the same. Similarly, for users with a large number of friends (e.g., thousands), the notification scale will the same (but different than the notification scale for the other users). Various different groupings of users can be applied.

In a further embodiment, the notification levels for a particular event type are specific to each user. For example, one user can have a notification scale for his photos that notifies him relatively frequently (e.g., a notification for each of the first 10 comments, and then for every 5^{th} comment thereafter), while another user will have a notification scale that notifies her relatively infrequently (e.g., a notification for each of the first 5 comments, and then for every 10^{th} comment thereafter). In still another embodiment, the notification levels for each event of different types for a user can be different. For example, a user may have a different notification scale for each individual photograph, video, update, etc. that the user has contributed, as shown in the table above.

If a user is a celebrity or otherwise had an especially large number of connections (e.g., thousands), the user's notification scale can be adjusted to reflect the large numbers of events that likely occur for this type of user. For example, a celebrity's notification scale levels can be at each of events 1-3, event 100, event 500, and event 1000. Thus, the celebrity gets a notification for each of the first three comments, and then only after the 100th comment (e.g., “100 people commented on your photo”), 500^{th} comment, 100^{th} comment, and so forth. Thus, a celebrity is notified less often of events since he likely receives so many events and each further notification is of less utility value to him. However, he may like to know when he has reached 1000 comments or other significant thresholds.

To determine the appropriate notification scale to create/store regarding events for a given user, the notification scale module 145 can collect various types of information about users. In one embodiment, the notification scale module 145 collects information about users from the user data store 190, including personal data, likes and dislikes of a user, fan clubs of a user, number of friends, historical number of photos, status updates, videos, wall posts, and the like associated with the user. This information can be used to select the notification scale (or scales) for events to the user. For example, a set of preconfigured notification scales can be defined for different categories of users based on the number of their friends, with a first notification scale defined for users with 1 to 25 friends, another scale for users with 26 to 50 friends, another scale for users with 51 to 100 friends, another scale for users with 101 to 200 friends, and so forth. These scales can be general (applicable to all events for each user), or specific (applicable only to status updates by the user). For each type of event or underlying content object (e.g., photo, wall post), a set of preconfigured notification scales can also be defined also based on different overall numbers of events. For example, one notification scale can be defined for users who contribute only a small number of photos (e.g., with frequent notifications), and another notification scale can be defined for users who contribute a very large number of photos (e.g., with less frequent notifications). The same approach can be used for other content types.

In another embodiment, users can receive notifications of events or content for which they are interested, in the absence of an interaction by another user. For example, if a user's profile data indicates that he is a fan of a particular television show, the user can receive notifications of events relating to the television show. Since there is likely to a very large number of such events (e.g., comments by other users), the user's notification scales can be adjusted to provide the user with notifications at only significant levels (e.g., every 100^{th} comment), rather than every single event. Thus, the events involving the television show can be weighted differently than other events so the user is more likely to get notifications regarding the television show (e.g., each television show event can be treated as if multiple events had occurred).

The notification scale module 145 can also retrieve information from a feedback store 180 which collects explicit and implicit feedback from users that can be used to adjust the notification scales. Users can provide explicit feedback on notifications by indicating whether the notification was helpful, whether too many or not enough notifications were received, and so forth. The explicit feedback can be provided in the form of votes or ratings regarding notifications, a feedback window, a survey, etc. Explicit feedback can be provided by an interface where users can select one or more icons or links to provide votes/ratings (e.g., a star or numerical rating, a thumbs up or down icon, etc.), can fill out a survey by selecting checkboxes and providing comments, and so forth. Users can provide implicit feedback by interacting with notifications (e.g., reviewing or clicking on a link in the notification). From the feedback stored in feedback store 180, the notification scale module 145 can determine user patterns (e.g., a particular user prefers frequent notifications on photos, but not on wall posts; the user prefers to receive all notifications having to do with a particular band; the user prefers more frequent notifications regarding family photos than other photos).

One type of feedback that the system monitors is whether the user accesses a particular notification that has been provided to the user. A notification can be provided as an email with a link to the underlying event (e.g., a link to the comment on the user's photo), or as a posting to the user's home page, also with link to the event. The system maintains state on whether the user accesses the link in the notification, and further maintains an “unread count” which is a count of the number of notification links that have not been accessed by the user. Where the user maintains a high unread count for a period of time (e.g., one week), the notification scale module 145 can adjust the notification scales being used for the user to reduce the overall notification rate. This adjustment can be done iteratively by the notification scale module, so as to progressively reduce the unread count.

The notification scale module 145 filters the information in the event log 160 prior to determining an event count for application to a notification scale. In one embodiment, the information is filtered by the notification scale module 145 so that only events relating to him that were taken by his friends or direct connections (as opposed to including friends of friends, strangers, etc.) are counted for the purposes of determining whether a notification is to be provided.

In some embodiments, this filtering is especially important, particularly where a user joins or “subscribes” to a thread by commenting on another user's comment or adding to a string of comments. For example, ten users might comment on a particular item posted on the system 100. User A might add the eleventh comment. Before User A commented or subscribed to the thread, he may not have been a part of the thread at all. However, once he has added a comment, he has subscribed to that thread, and may wish to then track the comments that follow his. In one embodiment, each comment that follows User A's comment is counted in the event count and applied to User A's own notification scale to determine whether a notification is sent to User A. Alternatively, the comments that follow are first filtered for User A's friends, and thus only these filtered comments are counted in the event count used for the notification scale. For example, there could be thousands of comments following User A's, but only a small number (e.g., 10) from User A's friends. Counting just those from User A's friends for application to User A's notification scale ensures that User A receives appropriate notifications for events that he likely values.

The events in the event log 106 can also be filtered by importance or salience of a user. Certain users (“super-users”) such as celebrities, or those with a very large number of friends or other factors, may have more significance within the social networking system 100, so it is more important to get notifications of events created by these super-users. For example, while User A may want notifications only for his friends' comments that follow his, he may also want included a notification of certain people of interest to him. For example, if User A is a fan of celebrity X (e.g., as indicated by user data stored in user data store 190), User A may want to know if celebrity X adds a comment following User's A comment. Thus, events pertaining to super-users may generate notifications, independent of the event count, thus providing an exception-basis for the notifications. Similarly, separate notification scales can be applied, as described above, for especially important users. Weighting can also be applied, as described below in relation to affinity scoring

The notification scale module 145 can also apply time-dependent criteria to notification scales. Notification scales can be time-dependent in that they can be replaced with new scales on some time-driven basis. A thread of comments/events on a particular item or interaction can come to an end at some point, for example when no further comments on posted for 30 days. If a new event for that item/interaction occurs later, a new notification scale can be created/store for this new thread, including restarting the event count for the particular event and notification scale. In another embodiment, the notification scales are removed/restarted after a set period of time (e.g., 12 hours, a day, 3 days, a week, a month, etc.).

The notification scale module 145 can also apply different notification scales or weighting for special events, like birthdays, holidays, etc. For example, User A can receive a notification of every birthday comment or birthday gift sent to him via the social networking system, even though his notification scale would normally limit the number of notifications sent.

The notification scale module 145 can also take into account affinity scores for a user regarding another user who created a new event. The affinity scores are stored in the affinity score store 356. An affinity score indicates the interest or degree of relationship/interest that one user has in another user. The affinity score can be used by the notification scale module 145 to weight (i.e., increase or decrease) the contribution an event has to the event count for a notification scale (so that the contribution of each event of a high affinity user is greater than the contribution of each event by the other users, so the next level is reached on the notification scale with fewer events). This allows the notification scale module 145 to provide the user with more notifications regarding new events by users with whom he has a stronger connection (i.e., a higher affinity score) than with other users. For example, events created by a user's family may be particularly important to the user, but he may only want to be notified after an accumulation of events. This can be achieved by, for example, counting each event from one of his children as if five events had occurred, and each event that occurred from his wife as if ten events had occurred. Thus, the events can be weighted according to User A's affinity for his relatives. Weights can be absolute numbers, for example setting an event count to 5, or relative numbers, like a multiplier of 5 applied to a pre-existing count for an event. Weights can also be thresholded or otherwise selected as a function based on affinity, e.g. for an affinity score scaled to 0-1, a weight can be left unchanged when the affinity is <0.5; when an affinity score is 0.50 to 0.75, an event can be counted as five events (i.e. multiply by five) before adding to the event count; when an affinity is 0.76 to 0.90, an event can be counted as ten events (i.e. multiply by 10); when an affinity score is >0.90, an event can be counted as twenty events (i.e. multiply by 20). Thus, a new event by a high affinity user can cause a jump to the next level in the notification scale, resulting in a notification being sent regarding that user. In other embodiments, where User A wants a notification of events by particular users (e.g., family members, separate notification scales can be created for those users, as explained previously.

In general, the events associated with each of the examples above can be given their own scales or can be given weights so their postings count more than other events. In some embodiments, this can be generalized to real value or fractional weights for particular users, types of events, etc. In further embodiments, filters are implemented by applying a weight of zero to desired events. By default, all events can be considered to have a weight of one, unless otherwise given a specified or custom weight. In such embodiments, the weight is applied when the current count/position on the notification scale is determined. For example, an event by created by a user with a weight of zero does not contribute to the event count. An event created by a user with a weight of one counts as one event by a user. However, an event created by a user with a weight of five counts as five events, and thus increments the event count by five.

Returning to FIG. 1, the notification module 135 provides a notification of the new event to the user in response to a determination (e.g., by the notification scale module 145) that a current count of the number of events including the new event has reached the specified number of events for a next level of notification utility. As illustrated above, the notification module 135 can aggregate a specified number of new events that have occurred into a single summary notification to be provided indicating that multiple new events have occurred since a last notification sent to the user (e.g., “1000 more people have commented on your content”).

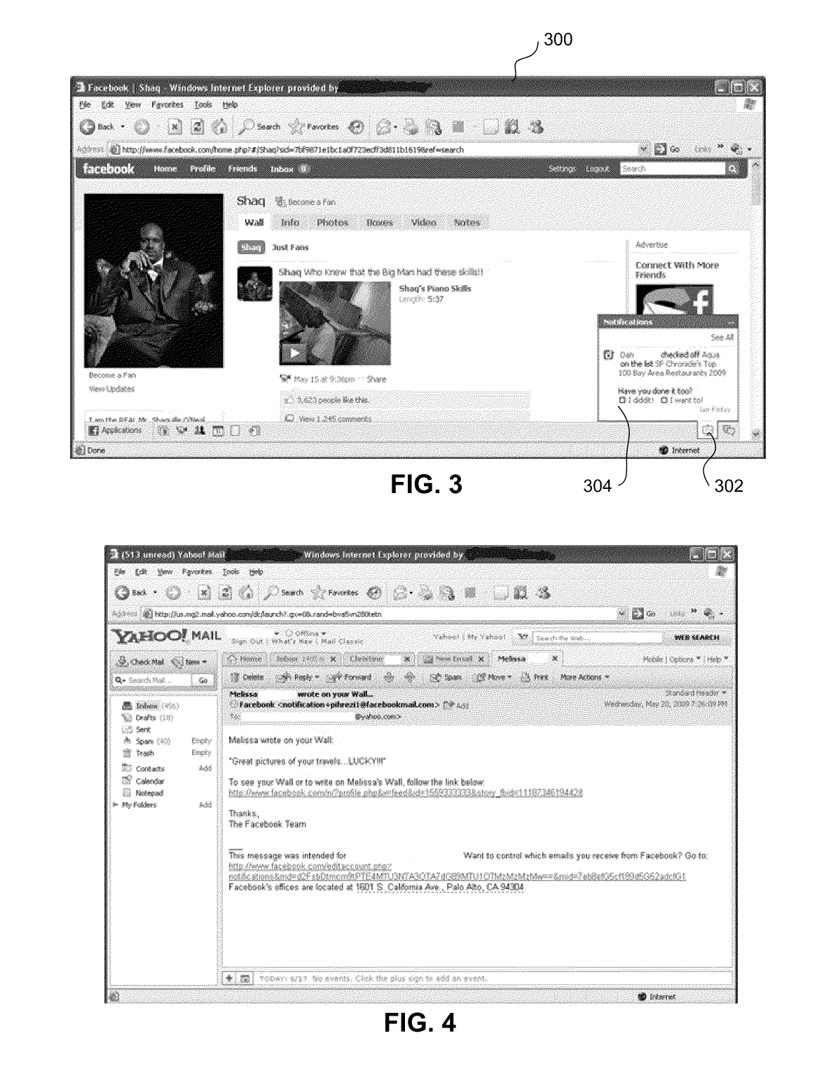

The notifications sent to users can be provided in various ways. In one embodiment, the notification is provided to the user on a web page of a social networking system (e.g., in a notification area on the page or in a pop-up or collapsible notification window on the page). FIG. 3 is a screen shot of a web page 300 (e.g., a user's homepage) on a social networking system. On this web page 300, an icon 302 is provided in the corner which the user can select to review his notifications. When selected, a collapsible notification window 304 pops up in the corner of the page 300, as shown in FIG. 3, providing the user's current notifications. In another embodiment, the notification is provided to the user via a message sent to a client device 150 of the user (e.g., an email, a SMS message, etc.). FIG. 3 is a screen shot of a web page for an email program showing an email notification to a user of a social networking system that her friend wrote on her wall. In some embodiments, both the notification types of FIGS. 3 and 4 are used to notify a user.

Though the description above focused on a social networking system embodiment, the above systems are not limited to this embodiment. For example, in another embodiment, the social networking system is implemented on an application running on a client device 150 (e.g., a portable communications device) that accesses information from the social networking system using APIs or other communication mechanisms. Similarly, various other implementations for the social networking system are also possible.

### V. Process for Scaling Notifications

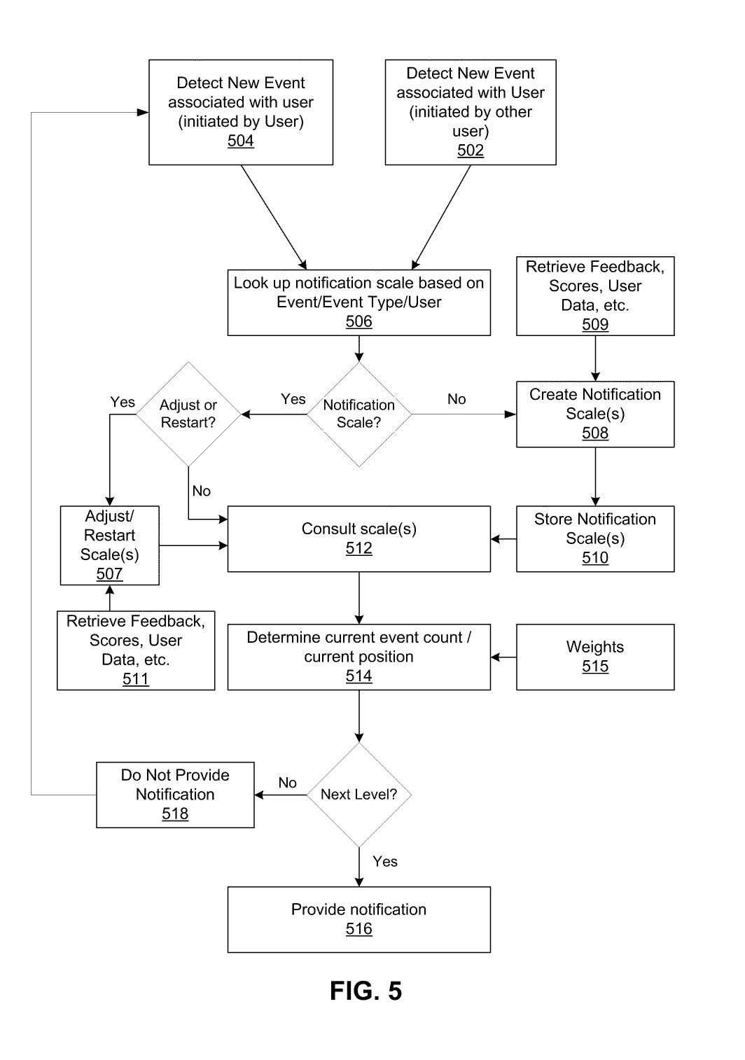

Referring now to FIG. 5, there is shown a sequence diagram illustrating a sequence of events and logic for scaling notifications provided to a user regarding new events associated with the user, according to some embodiments of the invention. It should be understood that these steps are illustrative only. Different embodiments may perform the illustrated steps in different orders, omit certain steps, and/or perform additional steps not shown in FIG. 5.

As shown in FIG. 5, the social networking system can detect 502, 504 a new event associated with a user. In one case, the system detects 502 that another user has taken an action (e.g., posted a particular content item) or otherwise interacted with the social networking system. This is thus the new event that was initiated by this other user's action. For example, user A could post a comment on user B's wall or could send a connection request to user B, thereby generating a new event associated with user B. In another case, the social networking system can detect 504 a new event associated with a user where that user initiated the action leading to the new event. The new event is thus the other user's response to the action/initiation by the user. For example, a user A can post a status update, and social networking system can detect 504 that user B commented on this update (the new event associated with user A).

Upon detection 502, 504, the social networking system will determine whether or not to provide a notification to the user regarding the new event associated with him. The social networking system can then look up 506 the notification scale from which it can determine whether to provide a notification. As explained above, there can be different notification scales for different users, particular event types, or for instances of those event types. In some cases, there are also specialized or customized scales for users that are customized based on feedback received by the user, based on affinity scores, based on importance/salience of the user creating the event, based on time dependencies, based on user preferences/likes/dislikes, etc. Thus, the social networking system can look up 506 the appropriate scale, whether it is customized or not, for the particular event/event type/user.

If there are no scales existing for the user or if a new scale needs to be created for the particular user/event/event type, the social networking system can create 508 such a notification scale and store 510 the scale. In creating the notification scale, the social networking system can consider the user, the event, the event type, etc. The social networking system can also retrieve certain stored information for use in creating a customized scale, including retrieving 509 feedback, affinity scores, certain user data, and other information. For example, the social networking system can retrieve 509 any stored feedback provided by the user, affinity scores, user data (including importance/salience information, user friends, user likes/dislikes, etc.), and other relevant information for creating a specialized scale. Once one or more scales have been created 508 and stored 510, the social networking system can then consult 512 the scale(s). The creation of scales associated with users/events/event types can be performed in advance as well, before detection of new events associated with the user.

If after looking up 506 the scale, however, there are already one or more scales existing for the user/event/event type, the social networking system can determine if the scale(s) need to be adjusted or restarted. If not, the social networking system can move directly to consulting 512 the existing scale(s). If so, the social networking system can adjust or restart 507 the scale(s). In adjusting 507 the scale, the social networking system can retrieve 511 any feedback, affinity score, user data, or any additional data that has become available for adjusting the scale. For example, if user A provides new feedback, this information can be used to adjust 507 an existing scale for user A to address this new information. As also explained above, sometimes a thread of comments or interactions can be restarted. Thus, there may already be a scale in existence on a topic, but the current position on that scale may be based on an old thread on the topic. In this case, the event count in the event log 160 can be returned to zero, and the position on the scale or count of events is adjusted to start again from the beginning or first notification level. In some embodiments, the deletion of old scales, and/or creation of new scales occurs regularly at set intervals, so the restarting 507 may not be necessary. The social networking system can then consult 512 the adjusted/restarted scale.

In some embodiments, based on the consultation 512 of the notification scale, the social networking system can determine 514 a current count of the number of events associated with the user that have occurred including the new event. The event count can be updated in the event log 160. The current count information provides the current position on the notification scale or the current level of notification utility. The level indicates the number of events that must occur before the user receives a notification about a new event. In some embodiments, weighting 515 is also considered in determining a current position on the scale. As explained above, certain events from certain users can be weighted for importance (e.g., Bob's wife's interaction with him is weighted higher than other interactions). Thus, the weights 515 applied can also affect the position on a scale.

If the current count of the prior events plus the new event is enough to have reached the next level of notification utility on the notification scale, the social networking system provides 516 a notification of the new event to the user. If the current count is not enough to reach the next level, the social networking system does not provide 518 a notification to the user, but instead waits for new events to occur. If a new event is detected 502, 504 for the user, the process begins again for the user to determine if the next notification utility level has been reached yet and so whether a notification can be provided 516 to the user.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, although the foregoing embodiments have been described in the context of a social networking system, it will apparent to one of ordinary skill in the art that the invention may be used with any electronic social networking system service, even if it is not provided through a website. Any computer-based system that provides social networking system functionality can be used in accordance with the present invention even if it relies, for example, on e-mail, instant messaging, or other form of electronic communications, and any other technique for communicating between users. The invention is thus not limited to any particular type of communication system, network, protocol, format or application.

Some portions of this description describe the embodiments of the invention in terms of servers and symbolic representations of operations on information. These server descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

What is claimed is:

1. A computer-implemented method for providing a notification to a user of a social networking system, the method comprising:
detecting an event associated with the user of the social networking system, wherein a plurality of other events are already associated with the user;
referencing a notification scale having a plurality of levels, each level representing a specified number of events associated with a single user necessary to trigger a notification; and
responsive to determining that the number of events associated with the user has reached the specified number of events to trigger a notification, providing a notification of the event to the user.

2. The method of claim 1, wherein the event is selected from a group consisting of: a comment from another user on content posted by the user, a comment from another user on text posted by the user, a connection request from another user, a post associated with the user by another user, an indication of a like or dislike associated with the user's activity, and a message from another user.

3. The method of claim 1, wherein providing the notification to the user further comprises providing the notification to the user on a web page of a social networking system.

4. The method of claim 1, wherein providing the notification to the user further comprises providing the notification to the user via a message sent to a client device of the user.

5. The method of claim 1, wherein providing the notification to the user further comprises providing a decreasing number of the notifications to the user for events as a total number of events associated with the user increases.

6. The method of claim 1, wherein providing the notification to the user further comprises providing a notification to the user for each new event up to a first level, providing a notification to the user for each group of new events of a first specified number up to a second level, and providing a notification to the user for each group of new events of a second specified number, which is larger than the first specified number, up to a third level.

7. The method of claim 1, wherein providing the notification to the user further comprises aggregating a specified number of events that have occurred into a single summary notification to be provided to the user indicating that multiple new events have occurred since a last notification sent to the user.

8. The method of claim 1, further comprising detecting that the user has posted a particular content item, and wherein detecting a new event associated with a user comprises detecting that an event has occurred in response to the user posting of the particular content item.

9. The method of claim 8, wherein the event comprises a comment or interaction with the posted content item by another user of the social networking system.

10. The method of claim 1, wherein referencing a notification scale having a plurality of levels further comprises:
retrieving, for each of a plurality of event types, a stored notification scale having a plurality of levels, each level associated with a specified number of events of the event type; and
responsive to the type of the event, using the notification scale for the event type to determine whether to provide notifications to the user regarding events of that event type.

11. The method of claim 10, wherein the event type is selected from a group consisting of: a comment from another user on content posted by the user, a comment from another user on text posted by the user, a connection request from another user, a post associated with the user by another user, an indication of a like or dislike associated with the user's activity, and a message from another user.

12. The method of claim 1, wherein referencing a notification scale having a plurality of levels further comprises:
retrieving, for each of a plurality of specific content items associated with the user, a stored notification scale having a plurality of levels, each level associated with a specified number of events occurring in response to the specific content item; and
according to the specific content item, using the notification scale for the content item to determine whether to provide notifications to the user regarding events related to the content item.

13. The method of claim 12, wherein the specific content item is selected from a group consisting of: a posted photo or video, a text entry, a wall post, a like or dislike, and a connection request.

14. The method of claim 1, wherein referencing a notification scale having a plurality of levels further comprises determining a current count of the number of events associated with the user that have occurred including the detected event.

15. The method of claim 1, wherein referencing a notification scale having a plurality of levels further comprises adjusting a stored notification scale to incorporate feedback from the user regarding prior notifications provided.

16. The method of claim 1, wherein referencing a notification scale having a plurality of levels further comprises adjusting a stored notification scale to incorporate affinity information indicating an interest of the user in the other user who created the event.

17. A computer system for providing a notification to a user of a social networking system, the system comprising:
an event detection module for detecting an event associated with the user of the social networking system, wherein a plurality of other events are already associated with the user;
a notification scale module for referencing a notification scale having a plurality of levels, each level associated with a specified number of events associated with a single user necessary to trigger a notification;
a notification module for providing a notification of the event to the user responsive to determining that the number of events associated with the user has reached the specified number of events to trigger a notification.

18. The system of claim 17, wherein the event is selected from a group consisting of: a comment from another user on content posted by the user, a comment from another user on text posted by the user, a connection request from another user, a post associated with the user by another user, an indication of a like or dislike associated with the user's activity, and a message from another user.

19. The system of claim 17, wherein the notification module is further configured for providing a decreasing number of the notifications to the user for events as a total number of events detected for the user increases.

20. The system of claim 17, wherein the notification module is further configured for aggregating a specified number of events that have occurred into a single summary notification to be provided to the user indicating that multiple events have occurred since a last notification to the user.

21. The system of claim 17, wherein the event detection module is further configured for detecting that the user has taken an action regarding a particular content item, and the event detection module is further configured for detecting that a new event has occurred in response to the action regarding the particular content item, wherein the new event comprises a comment or interaction with the particular content item by another user of the social networking system.

22. The system of claim 17, wherein the notification scale module is further configured for:
storing, for each of a plurality of event types, a notification scale having a plurality of levels, each level associated with a specified number of events of the event type; and
responsive to the type of the event, using the notification scale for the event type to determine whether to provide notifications to the user regarding events of that event type.

23. The system of claim 22, wherein the event type is selected from a group consisting of: a comment from another user on content posted by the user, a comment from another user on text posted by the user, a connection request from another user, a post associated with the user by another user, an indication of a like or dislike associated with the user's activity, and a message from another user.

24. The system of claim 17, wherein the notification scale module is further configured for:
storing, for each of a plurality of specific content items associated with the user, a notification scale having a plurality of levels, each level associated with a specified number of events occurring in response to the specific content item; and
responsive to the specific content item, using the notification scale for the content item to determine whether to provide notifications to the user regarding new events occurring in response to the content item.

25. The system of claim 24, wherein the specific content item is selected from a group consisting of: a posted photo or video, a text entry, a wall post, a like or dislike, and a connection request.

26. The system of claim 17, wherein the notification scale module is further configured for determining a current count of the number of events associated with the user that have occurred.

27. The system of claim 17, wherein the notification module is further configured for providing notifications to the user for a first N events, and exponential decay is applied after the first N events for providing a notification for every X events, where X is a specified number of events.

28. The system of claim 17, wherein the notification scale module is further configured to restart a count of events for the user after a lapse of a specified period of time between events.

29. The system of claim 17, wherein the notification scale module is further configured for automatically applying different scales to different users to scale notifications provided to users according to a number of connections a user has to other users in the social networking system.

30. The system of claim 17, wherein the notification scale module is further configured for automatically applying different scales to different content items associated with different users to scale notifications sent to users according to a number of notifications a user has previously received regarding each of the content items.

31. A computer-readable storage medium storing executable computer program instructions for providing a notification to a user of a social networking system, the computer program instructions comprising instructions for performing the steps comprising:
detecting an event associated with the user of the social networking system, wherein a plurality of other events are already associated with the user;
referencing a notification scale having a plurality of levels, each level associated with a specified number of events associated with a single user necessary to trigger a notification;
responsive to determining that the number of events associated with the user has reached the specified number of events to trigger a notification, providing a notification of the event to the user.

32. The computer-readable storage medium of claim 31, wherein providing the notification to the user further comprises providing a decreasing number of the notifications to the user for new events as a total number of events detected for the user increases.

33. The computer-readable storage medium of claim 31, further comprising creating and storing different notification scales for different instances of events of an event type.

34. The computer-readable storage medium of claim 31, wherein referencing a notification scale having a plurality of levels further comprises determining a current count of the number of events associated with the user that have occurred, wherein the current count indicates a current position on the notification scale, the current position indicating a number of events that must occur before the user receives a notification about an event.

35. A computer-implemented method for providing a notification to a user of a social networking system, the method comprising:
storing a first notification scale having a plurality of levels, each level representing a first specified number of events;
storing, for a second user connected to the first user in the social networking system, a second notification scale that is customized to reflect a higher degree of interest of the first user in the second user than in other users connected to first user, each level representing a second specified number of events that is fewer than the first specified number of events;
detecting, by the second user, an event associated with the first user; and
responsive to determining that the number of events associated with the user has reached the second specified number of events to trigger a notification, providing a notification of the event to the first user.

36. The method of claim 35, further comprising providing, based on the second notification scale, more notifications to the first user regarding events by the second user than for events by other users in whom the first user has a lower degree of interest

37. The method of claim 35, wherein a fewer number of events are required to reach a next level of the second notification scale than for the first notification scale.
